(19) United States
(12) Patent Application Publication
(10) Pub. No.: US 2026/0185877 A1
(43) Pub. Date: Jul. 2, 2026

(54) SYSTEM AND METHOD FOR MONITORING MOISTURE CONTENT OF PRODUCTS ON A PRODUCTION LINE

(71) Applicant: YORAN IMAGING LTD., Timrat (IL)

(72) Inventors: Yoav WEINSTEIN, Atlit (IL); Eran SINBAR, Shorashim Misgav (IL)

(21) Appl. No.: 19/546,961

(22) Filed: Feb. 23, 2026

Related U.S. Application Data
(63) Continuation of application No. PCT/IL2024/050859, filed on Aug. 27, 2024.
(60) Provisional application No. 63/535,332, filed on Aug. 30, 2023.

(51) Int. Cl. G01J 5/00; G01J 5/80

(52) U.S. Cl. CPC G01J 5/0037; G01J 5/80; G01J 2005/0077

(57) ABSTRACT

The present invention relates to a method and system for identifying moisture content of produce and/or products on a production line.

### CROSS REFERENCE TO RELATED APPLICATIONS

This application is a Bypass Continuation of PCT Patent Application No. PCT/IL2024/050859 having International filing date of Aug. 27, 2024, which claims the benefit of priority of U.S. Provisional Patent Application No. 63/535,332 filed Aug. 30, 2023, the contents of which are all incorporated herein by reference in their entirety.

### FIELD OF THE INVENTION

This invention relates to a method and system for identifying moisture content of produce and/or products on a production line.

### BACKGROUND OF THE INVENTION

In many fields, the moisture content during processing and of the final product can affect the quality of the product. For example, during processing, if a mixture or compound is too wet or too dry it may not mix completely, may not react completely, and may produce a product with an undesired texture, color, weight, hardness, look or consistency.

Additionally, if the final product contains too much moisture, the shelf life of the product may be affected, e.g., shortening the time to spoilage, facilitating the production of impurities, reducing the strength of the product, etc. Further, certain moisture levels can encourage the growth of microorganisms, e.g., bacteria, fungi, etc. Furthermore, if the final product is too wet or too dry, the product may not meet customer expectations (e.g., the product may lose its crunch, feel sticky, etc.) or may not meet the requirements of various regulatory bodies.

Therefore, the moisture content during processing and of the final product needs to be carefully monitored and controlled in both consumables and non-consumable products. Several industries in particular have strict controls relating to moisture content, e.g., tobacco industry, food industry, pharmaceutical industry and cosmetic industries.

Products and/or produce, such as, coatings, powders, tobacco, plastics, soil, wood, pharmaceutical products, cosmetics, nylon, ceramics, baked goods (e.g., snacks, chips, puffs, pretzels, etc.), roasted goods (e.g., coffee beans, cacao beans, nuts, etc.), dried products (e.g., dried fruit, meat, vegetables), salted products (e.g., meat, etc.), candied products (e.g., sweets, fruit, etc.), fresh fruit and vegetables, etc. require careful monitoring and control of moisture content both during processing and in the final product, e.g., prior to packaging.

Current methods for detecting and/or identifying moisture content are time consuming and generally require physically taking a sample of the product at specific intervals (e.g., every 5 minutes, every 20 minutes, etc.) from a conveyor of the production line to the laboratory for testing, which in itself may affect the measurement.

Therefore, there is a need for a rapid, accurate, real-time method and system for identifying the moisture content both during processing and in the final product.

### SUMMARY OF THE INVENTION

This invention relates to a method and system for identifying moisture content of produce and/or products on a production line.

Some embodiments relate to a method for inspecting moisture content of a product on a production line, the method comprising:
imaging at least a part of the production line using at least one imaging sensor, wherein the at least one imaging sensor is positioned and configured to enable imaging of at least part of the production line, and wherein the imaging sensor is operative at a wavelength in the range between about 0.01 μm-about 14 μm;
measuring a grey level in at least one of images obtained from the imaging;
computing the moisture content of the product based on the measured grey level; and
determining, based on the computed moisture content an operational property of the production line.

According to some embodiments, the method may include at least one imaging sensor which may be positioned at or following a product preparation station, but prior to a packaging station of the production line.

According to some embodiments, the method may include detecting a scattering of the grey level in at least one image and/or determining a spread of the product on a conveyor of the production line based thereon.

According to some embodiments, the method may include determining an operational property of the conveyor of the production line based thereon.

According to some embodiments, the method may include detecting a size and/or shape of the produce, based on at least one image.

According to some embodiments, the method may include determining an operational property of an extruder of the production line based on the detected size and/or shape.

According to some embodiments, the method may include computing the moisture content of the product comprises applying an artificial intelligence (AI) algorithm and/or big data analytics on at least one image of images.

According to some embodiments, the method may include issuing an alert if the at least one operational property deviates from a predefined range. According to some embodiments, the method may include determining the operational property of the production line (e.g., product preparation station) comprises applying an AI algorithm and/or big data analytics on a plurality of images.

According to some embodiments, the method may include computing a trend in a detected and/or predicted moisture content of the product based on the AI algorithm and/or big data analysis.

According to some embodiments, the trend may be indicative of performance of the production line, a contamination, a deformation, incorrect texture, issue with an ingredient, uneven heating, fluctuation in heating, a decrease or increase in product preparation station temperature, increased or decreased moisture content, humidity along the production line, or any combination thereof.

According to some embodiments, the method may include issuing an alert if the computed trend is indicative of a change from a predefined range in at least one parameter.

According to some embodiments, the at least one parameter is selected from radiation intensity of thermal radiation, distribution pattern of a radiating product on the surface of a conveyor of the production line, shape of the product, or any combination thereof.

According to some embodiments, the method may include recommending one or more steps to be taken to correct a computed trend in a detected and/or predicted moisture content of the product.

According to some embodiments, the method may include heating the product prior to imaging, wherein the heating may include baking, cooking, roasting, drying, dehydrating, heat sealing, firing, glazing, melting, extruding, thermosetting, welding, hot gluing, laminating, or any combination thereof.

According to some embodiments, the imaging may be performed at an Infra-Red (IR) wavelength in the range between about 8 μm-about 14 μm (LWIR), about 3 μm-about 5.4 μm (MWIR), about 1 μm-about 3 μm (SWIR), about 0.9 μm-about 1.7 μm (NIR), or any combination thereof.

According to some embodiments, the method may include a second imaging by a second imaging sensor positioned and configured to enable imaging of at least part of the production line e.g., after heating of the product.

According to some embodiments, the second imaging may be performed at a wavelength in the range between about 0.01 μm-about 0.4 μm (UV) and/or at a wavelength between about 8 μm-about 14 μm.

According to some embodiments, the method may include a third imaging by a third imaging sensor configured to image the product after packaging thereof.

According to some embodiments, the method may include inspecting moisture content of the product may further be based on the second/third imaging of the production line.

According to some embodiments, the product may be a comestible product. According to some embodiments, the comestible product may be selected from the group consisting of: snack, coating, a baked product, glazed product, a salted food product, a dried food product, pharmaceutical product, fresh produce, or any combination thereof. Each possibility is a separate embodiment. According to some embodiments, the product may be a non-comestible product, such as, but not limited to toilet paper, soap, a cosmetic product, a tobacco product, wood, powder or any other product, preferably a product which requires a certain moisture content to be considered proper. Each possibility is a separate embodiment.

According to some embodiments, the method may include illuminating the product thereby increasing an image contrast between the product and its surroundings.

Some embodiments may relate to a product moisture content inspecting system comprising:
a production line;
a first imaging sensor operative at a wavelength in the range between about 0.01 μm-about 14 μm, wherein the first imaging sensor is positioned and configured to enable imaging of at least part of the production line; and
a processor configured to:
measure a grey level in at least one image obtained from the imaging,
compute the moisture content of the product based on the measured grey level, and
determine based on the computed moisture content, an operational property of the production line.

According to some embodiments, the processor may be configured to detect a scattering of the grey level in at least one image and/or to determine a spread of the product on a conveyor of the production line based thereon.

According to some embodiments, the operational property may be a property of the conveyor of the production line based thereon.

According to some embodiments, the processor may be configured to detect a size and/or shape of the produce, based on at least one image.

According to some embodiments, the processor may be configured to determine an operational property of an extruder of the production line based on the detected size and/or shape.

According to some embodiments, computing the moisture content of the product may include applying an artificial intelligence (AI) algorithm and/or big data analytics on a plurality of images.

According to some embodiments, determining the operational property of the product preparation station may include applying an AI algorithm and/or big data analytics on a plurality of images.

According to some embodiments, further comprising heating the product prior to imaging, wherein the heating may include baking, cooking, roasting, drying, dehydrating, heat sealing, firing, glazing, melting, extruding, thermosetting, welding, hot gluing, laminating, or any combination thereof.

According to some embodiments, the system may include a second imaging sensor, wherein the imaging by said second imaging sensor is performed at a wavelength in the range between about 1 μm-about 14 μm, and wherein the second imaging sensor is positioned and configured to enable imaging of at least part of the production line after heating of the product.

According to some embodiments, the imaging by said second imaging sensor may be performed at a wavelength in the range between about 8 μm-about 14 μm.

According to some embodiments, the first imaging sensor and/or second imaging sensor may be positioned at or following the product preparation station, but prior to a packaging station of the production line.

According to some embodiments, the processor may be configured to determine the moisture content of a product by applying an AI algorithm and/or big data analytics on a plurality of images from said first imaging sensor and/or second imaging sensor.

According to some embodiments, the processor may be configured to determine at least one parameter of a plurality of images from at least one imaging sensor.

According to some embodiments, the processor may be configured to indicate that the at least one parameter of at least one image from the first and/or second imaging sensor is within or without a predefined range.

According to some embodiments, the processor may be configured to issue an alert if at least one parameter deviates from a predefined range.

According to some embodiments, the processor may be configured to identify a trend in at least one parameter of a plurality of images from the first and/or second imaging sensor.

According to some embodiments, the trend in at least one parameter may be identified by applying an AI algorithm and/or big data analysis.

According to some embodiments, the trend may be an indication of contamination, a deformation, incorrect texture, issue with an ingredient, uneven heating, fluctuation in heating, a decrease or increase in product preparation station temperature, increased or decreased moisture content, humidity along the production line, or any combination thereof.

According to some embodiments, the processor may be configured to issue an alert if the computed trend is indicative of a change from a predefined range in at least one parameter.

According to some embodiments, the at least one parameter may be selected from radiation intensity of thermal radiation, distribution pattern of a radiating product on the surface of a conveyor of the production line, shape of the product, or any combination thereof.

According to some embodiments, the system may have a sensitivity to a change in the moisture percentage level of at least about 0.2%.

According to some embodiments, there is provided a method for inspecting moisture content of a product on a production line, the method comprising:
imaging at least a part of the production line using at least one imaging sensor, wherein the at least one imaging sensor is positioned and configured to enable imaging of at least part of the production line, and wherein the imaging sensor is operative at a wavelength in the range between about 0.01 μm-about 14 μm;
measuring a grey level in at least one image obtained from the imaging;
computing the moisture content of the product based on the measured grey level; and
determining, based on the computed moisture content, a quality of the product.

According to some embodiments, there is provided a method for inspecting an operational quality of a production line, the method comprising: imaging a product on a production line conveyor belt using at least one imaging sensor, wherein the at least one imaging sensor is positioned at or following a product preparation station, to enable imaging of the product after said comestible products exits the product preparation station, and wherein the imaging sensor is operative at a wavelength in the range between about 8 μm-about 14 μm; measuring a thermal radiation, in at least one image obtained from the imaging; computing the moisture content of the product based on the measured thermal radiation; and determining, based on the computed moisture content an operational property (process health) of the production line.

According to some embodiments, the product preparation station comprises a drying station, a coating station, a baking station, a heating station, a roasting station, or a frying station.

According to some embodiments, the imaging comprises obtaining a time stamp for each image captured.

According to some embodiments, the method further includes detecting an amount and/or spread of the product based on the at least one image. According to some embodiments, determining the operational property of the production line is further based on the determined amount and/or spread of the product. According to some embodiments, the method further includes determining an operational property of the conveyor of the production line based thereon.

According to some embodiments, the method further includes detecting a size and/or shape of the produce, based on at least one image. According to some embodiments, determining the operational property of the production line is further based on the determined size and/or shape of the product. According to some embodiments, the method further includes determining an operational property of an extruder of the production line, based on the detected size and/or shape.

According to some embodiments, computing the moisture content of the product comprises applying an artificial intelligence (AI) algorithm and/or big data analytics on at least one image.

According to some embodiments, the method further includes issuing an alert if the at least one operational property deviates from a predefined range.

According to some embodiments, determining the operational property of the production line comprises applying an AI algorithm and/or big data analytics on a plurality of images.

According to some embodiments, the method further includes computing a trend in a detected and/or predicted moisture content of the product based on the AI algorithm and/or big data analysis. According to some embodiments, the trend is indicative of performance of the production line, a contamination, a deformation, incorrect texture, issue with an ingredient, uneven heating, fluctuation in heating, a decrease or increase in heating station temperature, increased or decreased moisture content of a heating station, humidity along the production line, or any combination thereof. Each possibility is a separate embodiment.

According to some embodiments, the AI algorithm is configured to conduct a root cause analysis a production line fault based on the trend. According to some embodiments, the method further includes recommending one or more steps to be taken to correct the fault, based on the root cause analysis.

According to some embodiments, the method further includes heating the product prior to imaging, wherein the heating comprises baking, cooking, roasting, drying, dehydrating, frying, glazing, coating, melting, extruding, or any combination thereof. Each possibility is a separate embodiment.

According to some embodiments, the method further includes a second imaging by a second imaging sensor configured to image the comestible product at another station of the production line and/or at a different wavelength. According to some embodiments, the other station is an extrusion station. According to some embodiments, the different wavelength is in the visible spectrum or UV spectrum.

According to some embodiments, the product is selected from the group consisting of: a coating, a snack, a baked product, a glazed product, a salted food product, a dried food product, pharmaceutical product, cosmetic product, tobacco product, a powder, or any combination thereof. Each possibility is a separate embodiment.

According to some embodiments, computing the moisture content includes identifying changes in the moisture percentage level of about 1% or less.

According to some embodiments, there is provided a moisture content inspecting system comprising: a production line comprising a product preparation station; a first imaging sensor operative at a wavelength in the range between about 8 μm-about 14 μm, wherein the first imaging sensor is positioned at or following the product preparation station, wherein the first imaging sensor is configured image a product conveyed on a conveyor belt of the production line after exiting the product preparation station; and a processor configured to: measure a thermal radiation in at least one image obtained from the imaging, compute the moisture content of the product based on the measured thermal radiation, and determine based on the computed moisture content, an operational property of the production line. Each possibility is a separate embodiment.

According to some embodiments, the product preparation station comprises a drying station, a coating station, a baking station, a heating station, a roasting station, or a frying station.

According to some embodiments, the imaging comprising obtaining a time stamp for each image captured.

According to some embodiments, the processor is further configured to detect amount and/or spread of the product. According to some embodiments, the determining the operational property of the production line is further based on the determined amount and/or spread of the product. According to some embodiments, the operational property is a property of the conveyor belt of the production line based thereon.

According to some embodiments, the the processor is further configured to measure a size and/or shape of the produce, based on at least one image. According to some embodiments, the determining the operational property of the production line is further based on the determined size and/or shape of the product. According to some embodiments, the production line further comprises an extruder and wherein the processor is further configured to determine an operational property of the extruder based on the detected size and/or shape.

According to some embodiments, the computing the moisture content of the product comprises applying an artificial intelligence (AI) algorithm and/or big data analytics on a plurality of images.

According to some embodiments, the determining the operational property of the production line comprises applying an AI algorithm and/or big data analytics on a plurality of images.

According to some embodiments, the processor is further configured to issue an alert if the computed moisture content deviates from a predefined range.

According to some embodiments, the processor is configured to identify a trend in the at moisture content over time, wherein the trend in the moisture content is identified by the applying of the AI algorithm and/or the big data analysis.

According to some embodiments, the system has a sensitivity to a change in the moisture percentage level of about 1% or less.

According to some embodiments, the system further includes a second imaging sensor configured to image the comestible product at another station of the production line and/or at a different wavelength. According to some embodiments, the other station is an extrusion station. According to some embodiments, the different wavelength is a wavelength in the visible or UV spectrum.

According to some embodiments, there is provided a method for inspecting an amount size and/or shape of a comestible product on a production line, the method comprising: imaging the comestible product using at least one imaging sensor, wherein the at least one imaging sensor is positioned prior to a packaging station of the production line and is configured to enable imaging of the comestible product while it is being conveyed on a conveyor belt of the production line, and wherein the imaging sensor is operative at a wavelength in the range between about 0.01 μm-about 14 μm; determining an amount, size and/or shape of the comestible product based on the imaging; and determining, based on the determined amount, size and/or shape, an operational property of the production line.

According to some embodiments, there is provided a production line comprising: an extrusion station; a product processing station; and a thermal imaging-based monitoring system comprising: a first imaging sensor operative at a wavelength in the range between about 8 μm-about 14 μm, wherein the first imaging sensor is positioned at or after the product processing station, wherein the first imaging sensor is configured image a comestible product conveyed on a conveyor belt of the production line at or after exiting the product processing station.

According to some embodiments, the production line further includes a second imaging sensor configured to enable imaging of the comestible product at another station of the production line and/or at a different wavelength. According to some embodiments, the other station is the extrusion station. According to some embodiments, the different wavelength is a wavelength in the visible or UV spectrum.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some, or none of the enumerated advantages.

In addition to the exemplary aspects and embodiments described above, further aspects and embodiments will become apparent by reference to the figures and by study of the following detailed descriptions.

### BRIEF DESCRIPTION OF THE FIGURES

The patent or application file contains at least one drawing executed in color. Copies of this patent or patent application publication with color drawing(s) will be provided by the Office upon request and payment of the necessary fee.

Examples illustrative of embodiments are described below with reference to figures attached hereto. In the figures, identical structures, elements, or parts that appear in more than one figure are generally labeled with a same numeral in all the figures in which they appear. Alternatively, elements or parts that appear in more than one figure may be labeled with different numerals in the different figures in which they appear. Dimensions of components and features shown in the figures are generally chosen for convenience and clarity of presentation and are not necessarily shown in scale. The figures are listed below.

FIG. 1: An exemplary photograph of an imaging sensor mounted on a production line in accordance with some embodiments.

FIG. 2: An exemplary graph of a system including a product preparation station functioning within predefined parameters, in accordance with some embodiments.

FIG. 3: An exemplary graph of a system including a product preparation station including several failure events, in accordance with some embodiments.

FIG. 4A and FIG. 4B: An exemplary graph and greyscale thermal image, respectively, of a system including a product preparation station with several failure events, resulting in high moisture content of the product, in accordance with some embodiments.

FIG. 5A and FIG. 5B: An exemplary graph and greyscale thermal image, respectively, of a system including a product preparation station with several failure events, resulting in low moisture content of the product, in accordance with some embodiments.

FIG. 6A and FIG. 6B: An exemplary graph and greyscale thermal image, respectively, of a system including a product preparation station with several failure events, prior to adjustment of the production line, and after adjustment resulting in required moisture content of the product, in accordance with some embodiments.

FIG. 7A-FIG. 7C: Exemplary greyscale thermal images of products with high moisture content, required moisture content and low moisture content, respectively, in accordance with some embodiments.

FIG. 8A-FIG. 8D: An exemplary graph and greyscale thermal images of a production line failure, with a sufficient amount of product, too much product, and an insufficient amount of product, respectively, in accordance with some embodiments.

FIG. 9A-FIG. 9C: Exemplary greyscale thermal images of a production line with a sufficient amount of product, too much product, and an insufficient amount of product, respectively, in accordance with some embodiments.

FIG. 10A and FIG. 10B: An exemplary graph and greyscale thermal image of a production line, respectively, showing a failure in extrusion/cutting in the production line, in accordance with some embodiments.

FIG. 11A and FIG. 11B: Exemplary optical and greyscale thermal images of a production line, respectively, showing a failure in extrusion/cutting in the production line, in accordance with some embodiments.

FIG. 12A and FIG. 12B: Exemplary optical and greyscale thermal images of a production line, respectively, where the production line is functioning within predefined parameters, in accordance with some embodiments.

FIG. 13A-FIG. 13C: Petit bear production line with thermal imaging setup and greyscale thermal images obtained therefrom.

FIG. 14: Exemplary graph showing a linear fit correlation between thermal signals and moisture content as measured by conventional lab techniques. The linear coefficient is calculated by applying linear regression.

### DETAILED DESCRIPTION OF THE INVENTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

Some embodiments relate to a method and system for identifying moisture content of produce and/or products on a production line and/or final product and/or produce, prior to packaging. Advantageously, the herein disclosed method and system enable evaluation of moisture content at a high resolution thus enabling identifying changes of 1% or less, 0.75% or less, 0.5% or less and 0.25% or less in the moisture content of a food product, e.g. in a range of 0.1%-0.5%, or 0.1-0.25% changes.

According to some embodiments, the method and system disclosed herein are further configured to monitor, a size of a food product, an amount of a food product being conveyed on a conveyer belt, the spreading of the food product on the conveyer belt, production rate of the food product, coating of a food product, heat dissipation within the product (e.g. of baked or fried food products) and the like. Each possibility and combination of possibilities is a separate embodiment.

According to some embodiments, both grey scale and morphology (structure of the image and intensity/grey scale) is evaluated. According to some embodiments, by combining grey scale and morphology it can be determined whether an identified defect in a product is a result of a moisture issue (e.g. problem with the product preparation station) or a problem of the size/amount/spread of the products (i.e. a problem with the extrusion of the product).

As used herein, the term “grey scale” grey level” and “grey scale level” may be used interchangeably and refer to a digital value of a measured thermal radiation level of each pixel in the thermal image.

As used herein, the term “product processing station” may refer to any station at which the product is dried, coated, baked, heated, roasted, fried or the like. Each possibility is a separate embodiment.

Advantageously, according to some embodiments, the method and system may provide rapid identification of the moisture content of a product such as food product, thereby facilitating time saving and reduction of costs. According to some embodiments, the method and system may be highly sensitive.

Moreover, the thermal imaging-based evaluation is easy to interpret as it provides images of the actual product, as compared to for example Raman spectroscopy which outputs spectra that required sophisticated analyses to retrieve information. The herein disclosed thermal imaging-based system and methods further enables intuitive interpretation of spread of a feature in the food product, e.g. certain regions may be found to be moist whereas other are not, thus providing clues as to the underlying cause of the problem.

Further advantageously, the method and system may provide a real time indication of moisture content of a mixture, product or produce. According to some embodiments, the method and system may facilitate prompt adjustment of production line parameters without a significant time lag between sampling, testing and analysis of the test results of a product to adjustment of the production line parameter.

Advantageously, according to some embodiments, the method and system may thereby reduce waste of time, material and resources, e.g., by disposing of products with an incorrect water content or having an unwanted property resulting from an incorrect water content during processing; or by adjusting production line parameters prior to an out of scope moisture content is reached or a short time after (limited number of) out of scope products have been packed. Moreover, as no illumination of the product is required, yet another source of energy waste is obviated and potential product damage resulting from the illumination is also avoided.

That is, according to some embodiments, advantageously the method and system may facilitate identification of trends in the moisture content, product size, heating temperature, failure of a station of the production line, and/or prediction thereof. According to some embodiments, an identified and/or predicted trend may be acted on swiftly, to adjust and/or improve one or more parameters of the production line. According to some embodiments, when there is a defect trend, a signal may be sent with alerts and or a halt of the production line may be triggered.

Non-limiting examples of products and/or produce may include: coating, powders, tobacco, plastics, soil, wood, pharmaceutical products, cosmetics, nylon, ceramics, baked goods (e.g., snacks, chips, puffs, pretzels, etc.), roasted goods (e.g., coffee beans, cacao beans, nuts, etc.), dried products (e.g., dried fruit, meat, vegetables), salted products (e.g., meat, etc.), candied products (e.g., sweets, fruit, etc.), fresh fruit and vegetables, etc. or any combination thereof. Each possibility is a separate embodiment.

According to some embodiments, the product may be a snack.

According to some embodiments, the product may be a powder.

According to some embodiments, the product may be a coating. Additionally, and/or alternatively, according to some embodiments, the product may be coated. According to some embodiments, the herein disclosed thermal-imaging-based system may be used to monitor and identify defects in the coating of a food product. As a non-limiting example, a chocolate coating of a granola bar can be evaluated as well as coatings of vitamins, medicaments and the like.

According to some embodiments, a product and/or produce moisture content inspecting system may include a production line, at least one imaging sensor positioned and configured to enable imaging of at least part of the production line and a processor configured to analyze one or more images from the at least one imaging sensor. According to some embodiments, at least one imaging sensor may be located at one or more locations along the production line, prior to packaging.

According to some embodiments, the system may facilitate inspection of the moisture content of one or more starting materials of the process, one or more intermediates, one or more processing stages of the production line, and/or the final product of the production process, prior to packaging. According to some embodiments, at least one imaging sensor may be positioned at or following a product preparation station, but prior to a packaging station/packaging sealing station of the production line.

According to some embodiments, the first imaging sensor and/or second imaging sensor may be positioned at or following various stations on the production line, e.g., at an extrusion station, a cutting station, at a product preparation station and/or at a packaging station e.g. before and/or after a sealing station of the packaging station. According to some embodiments, imaging by said first imaging sensor and/or said second imaging sensor may be performed on a portion of a conveyor of the production line, and/or at an exit of a conveyor of the production line, prior to packaging.

According to some embodiments, the processor may be configured to determine at least one parameter from a single image from an image sensor. According to some embodiments, the processor may be configured to determine at least one parameter of a plurality of images from at least one imaging sensor. According to some embodiments, the processor is configured to indicate that at least one parameter of the plurality of images from the first and/or second imaging sensor may be within or without a predefined range. According to some embodiments, the processor may be configured to issue an alert if at least one parameter deviates from a predefined range. According to some embodiments, at least one parameter may be selected from radiation intensity of thermal radiation, distribution pattern of a radiating product on the surface of a conveyor of the production line, shape of the product, or any combination thereof. Each possibility is a separate embodiment.

According to some embodiments, evaluation of a quality of a product may be based on a single or a few images, whereas analytics made on a plurality of images may be used for evaluation of the operation of the production line (also referred to herein as “production line health” and “process health inline monitoring”) or part thereof (e.g., a product preparation station), for computing a trend in the operation of the production line or part thereof and/or for predicting a future failure in the operation of the production line or part thereof.

As used herein, according to some embodiments, the term “heating” may refer to any process requiring applying a temperature above room temperature to a product or process, such as baking, cooking, roasting, drying, dehydrating, frying, glazing, melting, extruding, or any combination thereof. Each possibility and combination of possibilities is a separate embodiment.

According to some embodiments, the herein disclosed thermal imaging-based system may be further configured to monitor and identify defects in operations such as thermosetting, welding, hot gluing, laminating and the like. Each possibility and combination of possibilities is a separate embodiment.

According to some embodiments, at least one imaging sensor may be an optical sensor selected from a camera, ultraviolet (UV) camera, infra-red (IR) camera, a video camera, a photoelectric sensor, smart vision sensor, etc., or any combination thereof. Each possibility is a separate embodiment.

According to some embodiments, the system may make use of a combination of imaging sensors to identify and/or predict an issue, trend and/or potential problem, e.g., unsuitable water content, incorrect heating of a product, or intermediate, etc. According to some embodiments, combining the data from one or more imaging sensors may improve the quality and/or reliability of the data. According to some embodiments, combining the data from one or more imaging sensors may facilitate identification and/or prediction of an issue, trend and/or potential problem. According to some embodiments, combining the data from a plurality of images from one or more imaging sensors may facilitate identification and/or prediction of an issue, trend and/or potential problem.

According to some embodiments, the system and method disclosed herein may enable applying, optionally, thermal imaging and/or standard visual (VIS) imaging. According to some embodiments, the system and method may include applying image processing on the images to improve the reliability of the results, e.g., to reduce blurring due to the speed of the production line, increase contrast, clarity and/or sharpness, etc.

According to some embodiments, imaging may be performed at a wavelength in the range between about 0.01 μm to about 14 μm, and/or any sub-range therein. According to some embodiments, the imaging may be performed at an Infra-Red (IR) wavelength in the range of about 8 μm-about 14 μm (LWIR); about 3 μm-about 5.4 μm (MWIR); about 1 μm-about 3 μm (SWIR); about 0.9 μm-about 1.7 μm (NIR), or any combination thereof. Each possibility is a separate embodiment. According to some embodiments, the imaging may be performed at a wavelength in the range between about 0.01 μm-about 0.4 μm (UV), and/or any sub-range therein.

According to some embodiments, imaging may be performed by a first imaging sensor at a wavelength ranging between about 1 μm-about 14 μm (e.g., at an Infra-Red (IR) wavelength in the range between about 8 μm-about 14 μm (LWIR), about 3 μm-about 5.4 μm (MWIR), about 1 μm-3 μm (SWIR), 0.9 μm-about 1.7 μm (NIR), about 0.4 μm-about 0.76 μm, about 0.01 μm-about 0.4 μm (UV), and/or any sub-ranges therein, or any combination thereof.

According to some embodiments, imaging may be performed by a second imaging sensor at a wavelength ranging between about 1 μm-about 14 μm (e.g., at an Infra-Red (IR) wavelength in the range between about 8 μm-about 14 μm (LWIR), about 3 μm-about 5.4 μm (MWIR), about 1 μm-3 μm (SWIR), 0.9 μm-about 1.7 μm (NIR), about 0.4 μm-about 0.76 μm, about 0.01 μm-about 0.4 μm (UV), and/or any sub-ranges therein, or any combination thereof.

According to some embodiments, thermal imaging may be used alone and/or in conjunction with data signals from other sensors to provide data for use in a system and/or method as described herein.

According to some embodiments, the term “thermal imaging” (also known by the term “thermographic imaging”) as used herein may relate to a type of infrared (IR) imaging in which radiation emitted from a substance is detected based on the temperature and emissivity at one or more locations across the substance (according to Black Body radiation law), and IR images are produced according to the detected temperatures and emissivity. Typically, the amount of radiation emitted by a substance increases with temperature. Therefore, thermography may facilitate detecting variations in temperature and/or emissivity of a substance. For example, when viewed by a thermographic camera, warm objects can be differentiated from cooler backgrounds. Similarly, because of differences in emissivity, liquid-based materials (including liquids, creams, pastes, foams, etc.) may be differentiated from dry products using thermal imaging.

According to some embodiments, thermal imaging may be sensitive to heat change, spatial patterns and/or water molecule absorption. According to some embodiments, water molecules may vibrate intensely in the IR region absorbing spectral radiation from the observed product, thereby influencing its emissive ability to radiate light in the IR thermal imaging range.

According to some embodiments, the light intensity of the imaging may be captured as greyscale images. According to some embodiments, grayscale images may be the result of measuring the intensity of light at each pixel according to a particular weighted combination of frequencies (or wavelengths). The frequencies may be from anywhere in the electromagnetic spectrum (e.g., infrared, visible light, ultraviolet, etc.).

As used herein, according to some embodiments, the term “greyscale” may relate to an image in which the value of each pixel is a single sample representing only an amount of light; that is, it carries only intensity information. Grayscale images are composed exclusively of shades of gray, wherein the contrast ranges from black at the weakest intensity to white at the strongest having many shades of gray in between. The intensity of a pixel may be expressed within a given range between a minimum and a maximum, inclusive. This range may be represented as a grey level (digital level), e.g., as a range from 0 (or 0%) (total absence, black) and 1 (or 100%) (total presence, white), with any fractional values in between, or as a range between 0 to 256. Grayscale images intended for visual display are commonly stored with 8 bits per sampled pixel. This pixel depth allows 256 different intensities (i.e., shades of gray) to be recorded.

According to some embodiments, the grey level may be indicative of the moisture content of a material. According to some embodiments, the lower the moisture content percentage, the higher the grey level (digital level). According to some embodiments, the grey level may be sensitive to variations in the moisture content of a material. According to some embodiments, the grey level may be highly sensitive to a change in the moisture percentage level, e.g., sensitivity up to about 0.1%, about 0.2%, about 0.3%, about 0.5%, or about 1%. Each possibility is a separate embodiment. Preferably, the sensitive to a change in the moisture percentage level may be about 0.2%.

According to some embodiments, one or more imaging sensors may send a signal to one or more digital data processors. According to some embodiments, the signal may be a plurality of images of a portion of production line.

According to some embodiments, a processor may be configured to measure a grey level in a plurality of images obtained from the imaging of a portion of production line by one or more imaging sensors. According to some embodiments, the processor may be configured to compute the moisture content of the product and/or produce based on the measured grey level. According to some embodiments, the processor may be configured to determine based on the computed moisture content, an operational property of the production line or part thereof.

According to some embodiments, the processor may be configured to identify the moisture content of a product, by applying an artificial intelligence (AI) algorithm and/or big data analytics on the plurality of images obtained one or more imaging sensors, e.g., a first imaging sensor and/or a second imaging sensor.

According to some embodiments, a processor may be configured the operational property may be a property of the conveyor of the production line based thereon. According to some embodiments, a processor may be configured to determine an operational property of an extruder of the production line based on the detected size and/or shape. According to some embodiments, determining the operational property of a production line or part thereof (e.g., a product preparation station) may include applying an AI algorithm and/or big data analytics on the plurality of images. According to some embodiments, the machine learning algorithm provides root cause analysis e.g. based inter alia on an integrated analysis of both the moisture content and the morphology of the product and thus provide an indication whether an out-of-range moisture content is a result of a fault in the product preparation station or due to an irregular size of the product (fault in extrusion station) and or a result of clogging of the product on the conveyer belt (e.g. as a result of fault in conveyor belt operation). According to some embodiments, the root cause analysis may further take into consideration the time stamp of the defect. According to some embodiments, the AI may be further configured to trigger the output of a preventive and predictive alert based on the big data and/or trigger a halt in the production line if required in order to readjust the operation of the production line.

According to some embodiments, the AI model is or includes an AI image processing module. According to some embodiments, the AI image processing module uses advanced algorithms, neural networks, and data processing to analyze, interpret, and manipulate digital images, here thermal images. According to some embodiments, the AI image processing includes:

Collecting a large dataset of labelled images. The images are pre-processed, which may involve resizing, normalization, and data augmentation.

Feature are the extracted from the images. Convolutional Neural Networks (CNNs), a deep learning architecture, are commonly used for AI image processing. CNNs automatically learn and extract hierarchical features from images, here intensity (also referred to herein as grey level), morphology, pattern and time stamp.

The pre-processed images are fed into the CNN model for training whereafter a separate validation dataset monitors the model's performance during training and prevents overfitting

Once trained, the model is ready for inference, which processes new, unseen images to make predictions. The AI image processing model analyzes the features of the input image and produces predictions or outputs based on its training, here process health inline monitoring and root cause indication based thereon.

Post-processing techniques may be applied depending on the task to refine the model's outputs. The AI image processing models can be continuously improved through retraining with new data and fine-tuning based on user feedback and performance evaluation.

According to some embodiments, a processor may be configured to detect a scattering of the grey level in the plurality of images and determine a spread of the product and/or produce on a conveyor of the production line based thereon.

According to some embodiments, a processor may be configured to detect a size and/or shape of the produce, based on plurality of images of the production line.

According to some embodiments, a plurality of images from one or more imaging sensors may be input to an algorithm. According to some embodiments, an algorithm may identify and/or extract one or more features and/or one or more parameters from the plurality of images. According to some embodiments, an algorithm may identify and/or extract one or more features and/or one or more parameters from the time stamps of a plurality of images from one or more imaging sensors.

According to some embodiments, big data analysis may be applied on plurality of images from one or more imaging sensors. According to some embodiments, big data analysis may be applied on one or more features and/or one or more parameters extracted from a plurality of images from one or more imaging sensors. According to some embodiments, big data analysis may be applied on one or more features and/or one or more parameters extracted from the time stamps of a plurality of images from one or more imaging sensors.

As used herein, according to some embodiments, the term “big data analysis” may refer to a form of advanced analytics, which may involve complex applications with elements such as predictive models, statistical algorithms and what-if analysis powered by analytics systems. According to some embodiments, big data may include a plurality of data points, e.g., 10, 50, 100, 500, 1,000, 10,000, 100,000, 1,000,000, etc.

According to some embodiments, the big data analysis may have a holistic approach that relies on:
Trend analysis, for failure prevention; and
Statistical Process Control (SPC) software, for root cause analysis.

According to some embodiments, the big data analysis advantageously provides the following benefits:
Improvement of production efficiency and/or yield;
Increased Mean Time Between Failures (MTBF)—by alerting on a trend indicating reduced quality/efficiency of the production process, a failure that has not yet happened can be treated in time e.g., during routine maintenance;
Reduced failure time (i.e., the time during which the production line is in a failure mode); and
Increasing production rate inter alia due to the confidence in the real time quality analysis of the products.

According to some embodiments, the big data analysis may include applying machine learning algorithms on a plurality of images from one or more imaging sensors and/or at least one operational property or parameter. According to some embodiments, machine learning may be supervised. According to some embodiments, machine learning may be unsupervised. According to some embodiments, machine learning may include feature extraction. According to some embodiments, machine learning may include neural network algorithms (e.g., deep learning).

According to some embodiments, machine learning may include extracting one or more features from one or more imaging sensor data, e.g., images, electronic signals, grey scale level, time stamps, etc. According to some embodiments, big data analysis may be applied on one or more features. According to some embodiments, the moisture content of the product and/or produce may be computed by applying an AI algorithm and/or big data analytics on a plurality of images.

According to some embodiments, machine learning may include training on data sets including images of systems with various percentages of moisture content. According to some embodiments, machine learning may include training sets with labeled images. According to some embodiments, the labels may be applied manually to the images. According to some embodiments, grey level values may be assigned to various moisture content percentages, and may be labeled as such. According to some embodiments, the trained algorithm may be applied in the big data analysis.

According to some embodiments, data processing may include applying data processing algorithms. According to some embodiments, the data processing may include contrast analysis, edge detection, signal arithmetic, cross correlation between signals, convolution between signals or between a signal to a predefined parameter, spatial frequency transformation and/or spatial filtering methods, temporal frequency transformation and temporal filtering methods, Fourier transforms, discrete Fourier transforms, discrete cosine transforms, morphological processing, determining low and high intensity regions, intensity contours recognition, boundary tracing, line detection, texture analysis, histogram equalization, image deblurring, cluster analysis or any other suitable processing known in the art or combinations thereof. Each possibility is a separate embodiment. According to some embodiments, the processing may include deep learning. According to some embodiments, the processing may include OpenCV, and/or other real-time computer vision processors and/or programs.

According to some embodiments, the image data received by the system may include a time stamp. As used herein, the term “time stamp” relates to a sequence of characters or encoded information identifying when a certain event occurred, and may be accurate to a small fraction of a second, e.g., microseconds. Optionally, the time stamp may indicate the date and/or time of day, the number of seconds, minutes, hours, or days from when the system and/or process was initiated, etc. Optionally, time stamps may not be based on an absolute notion of time. Advantageously, when a defect is identified along with a time stamp, the ability to detect the underlying cause of the defect is significantly improved.

According to some embodiments, data analysis, such as big data analysis, may be applied to the time stamps of the data received by the system. According to some embodiments, the data analysis of the time stamps may facilitate identification of an issue, trend and/or potential problem. According to some embodiments, the data analysis of the time stamps may be predictive of an issue, trend and/or potential problem.

According to some embodiments, analysis may include applying big data analysis on at least one parameter, computing a trend in the performance of the production line based on the analysis, and/or providing an indication regarding a detected, identified and/or predicted process deficiency, such as, when the trend is indicative of a decline in the performance of the production line or part thereof, a malfunctioning part, etc. According to some embodiments, a trend may be indicative of contamination, a deformation, incorrect texture, issue with an ingredient, an uneven heating, a decrease or increase in oven temperature, increased or decreased moisture content, humidity along the production line, etc., or any combination thereof. Each possibility is a separate embodiment.

According to some embodiments, a trend may be used as the basis for a prediction regarding the behavior of the production line, and/or part thereof.

According to some embodiments, big data analysis may be applied on the data from one or more imaging sensors, from one or more workstations, from the entire production process, etc. According to some embodiments, the degree of resolution of the data may be selected when applying big data analysis. According to some embodiments, data from one or more imaging sensors may be stored in the cloud. According to some embodiments, big data analysis may be applied on the stored data.

According to some embodiments, AI (e.g., big data analysis) may be based on data from one or more signals from one or more sensors (e.g., images, etc.). According to some embodiments, data may be signals generated by one or more sensors and/or data processing algorithms (e.g., image processing algorithms applied to images, thermal images, etc.) and/or time stamps. According to some embodiments, big data analysis may be based on one or more signal processing algorithms. According to some embodiments, data processing algorithms may generate a signal and/or time stamp for each data signal (e.g., image, thermal image, parameter, etc.). According to some embodiments, deep learning may be applied on a signal and/or time stamp for each data signal generated by data processing algorithms. According to some embodiments, big data analysis may be based on deep learning of one or more signals (e.g., images, etc.) and/or on their time stamps. According to some embodiments, deep learning may be applied directly on data signals and/or on their time stamps.

According to some embodiments, the system may be connected to the internet of things (IOT). According to some embodiments, due to interaction between system and users and IOT infrastructures, the system may improve its performance on flight (e.g., by machine learning). According to some embodiments, the system may send information to one or more production line processors (e.g., a manufacturing execution system (MES)). According to some embodiments, one or more production line processors (e.g., a manufacturing execution system (MES)) may send and/or receive information to and/or from the system. According to some embodiments, the system may send information to a cloud (e.g., IOT network) and/or receive information from a cloud (e.g., IOT network).

According to some embodiments, the system and method may include computing a trend in a detected and/or predicted moisture content of the product based on the AI algorithm and/or big data analysis.

According to some embodiments, the trend may be an indication of contamination, a deformation, incorrect texture, issue with an ingredient, uneven heating, fluctuation in heating, a decrease or increase in product preparation station temperature, increased or decreased moisture content, humidity along the production line, or any combination thereof. Each possibility is a separate embodiment.

According to some embodiments, the processor may be configured to issue an alert if the computed trend is indicative of a change from a predefined value and/or range of at least one parameter. According to some embodiments, the at least one parameter may be selected from radiation intensity of thermal radiation, distribution pattern of a radiating product on the surface of a conveyor of the production line, shape of the product, or any combination thereof. Each possibility is a separate embodiment.

According to some embodiments, the system and method may include issuing an alert if a computed trend is indicative of a detected and/or predicted inefficiency and/or failure, e.g., a decrease in heating temperature, etc.

According to some embodiments, the system and method may include obtaining a plurality of data signals (e.g., images, grey levels, time stamps, etc.) captured during processing of a plurality of products, obtaining and/or determining one or more parameters, applying big data analysis on the plurality of data signals obtained from one or more imaging sensors during processing and on at least one parameter, and computing a trend in moisture content, and/or performance of the production line based on the analysis, and providing an indication regarding a detected and/or predicted process deficiency when the trend is indicative of a change (e.g., decrease, increase, etc.) in the performance of the production line or part thereof.

According to some embodiments, the terms “decrease” and “increase” may refer to a deviation of at least about 1%, at least about 5%, or at least about 10% from a defined value and/or range. Each possibility is a separate embodiment.

As used herein, the term “at least two”, when referring to images/signals obtained from one or more imaging sensors may refer to 2, 3, 4, 5, 10, 50, 100, or more images/signals. Each possibility is a separate embodiment.

According to some embodiments, obtaining two or more signals, e.g., at intervals may enable differentiating between signals. According to some embodiments, the determining of at least one parameter may be based on an integrated analysis of the signal taking into account the time and the interval between the signals. According to some embodiments, obtaining the time stamps of two or more signals may facilitate identification of an irregularity in the production process.

According to some embodiments, the time interval between subsequent images may be sub-seconds, seconds, minutes, hours, days, etc. Each possibility is a separate embodiment. According to some embodiments, the time interval between subsequent images may range between about 0.01 s to about 1 s, between about 1 s to about 10 s, between about 10 s to about 1 min, between about 1 min to about 25 mins, between about 25 mins to about 12 hrs, or between about 12 hrs to about 7 days, or sub-ranges therein. Each possibility is a separate embodiment.

According to some embodiments, the system and/or method may further be configured to identify trends indicative of and/or responsible for an inefficient production process. According to some embodiments, the identifying of trends may include big-data analysis and/or machine learning techniques, e.g., deep learning. According to some embodiments, when a defective trend is identified, the production line may be halted for inspection, calibration, repair, synchronization, cleaning, maintenance and/or the like, thereby preventing possible catastrophic failure as well as production of defect goods which need to be discarded.

As used herein, the term “integrated analysis” may refer to image processing including applying processing algorithms to data from an imaging sensor signal, e.g., image, etc., and identifying parameters deduced from at least one imaging sensor signal.

According to some embodiments, the processor unit may be an integral part of the production line. According to some embodiments, the processor may be an external and/or adjunct to the computing device, such as, but not limited to, a mobile, smartphone, tablet, desktop computer, laptop computer, VR device, and/or any dedicated computing device. Each possibility is a separate embodiment. According to some embodiments, the processor may be a virtual processor, such as an internet enabled device (i.e., cloud computing). According to some embodiments, the processor may be configured to monitor and/or identify issues, trends and/or predict potential problems (e.g., failure) in the production processing, e.g., applying processing algorithms, on the data obtained from one or more imaging sensors.

According to some embodiments, the processor may be configured to identify issues, trends and/or predict potential issues in the production process, based on an integrated analysis of data obtained from more than one imaging sensor. According to some embodiments, the integrated analysis may include applying processing algorithms to data obtained from more than one imaging sensor and identifying issues, trends and/or predict potential issues in the production process based on parameters deduced/extrapolated from at least one data signal obtained from each of the imaging sensors.

Reference is now made to the figures.

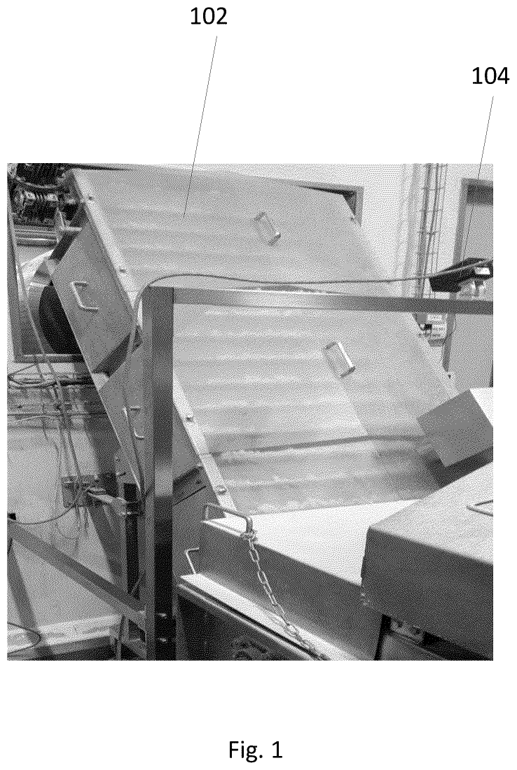

Reference is now made to FIG. 1, which is an exemplary photograph of an imaging sensor mounted on a production line in accordance with some embodiments. In FIG. 1, an imaging sensor 104 is mounted over a conveyer 102 and provides imaging of the products as they pass over this section of the production line.

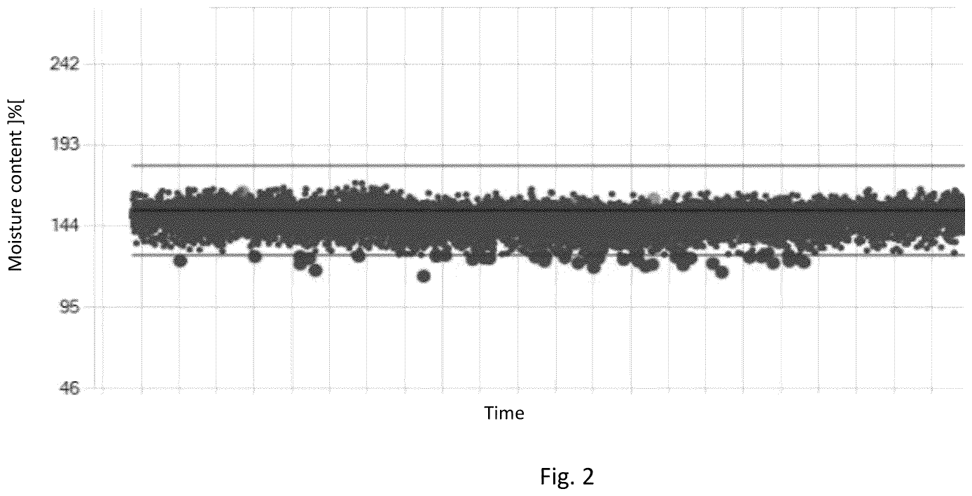

Reference is now made to FIG. 2, which is an exemplary graph showing the moisture content over time as determined using the herein disclosed thermal imaging-based system for evaluating moisture content (here of puffed snacks) exhibiting proper production line functioning. Each dot represents a single snack or a group of snacks together. I.e., each dot in the graphs may be indicative of an average, a standard deviation or any other image processing value derived from one or a plurality of thermal images.

As can be seen in FIG. 2, the majority of the spots (in green) fall between predefined upper and lower limits (purple lines) of a desired percent moisture content as determined based on the image grey levels (y-axis) over the time period (x-axis) and only a few outliers (in red) are observed. The measurements are conducted at a high rate (here every second) and thus provide a real time identification of the moisture content of the snack product.

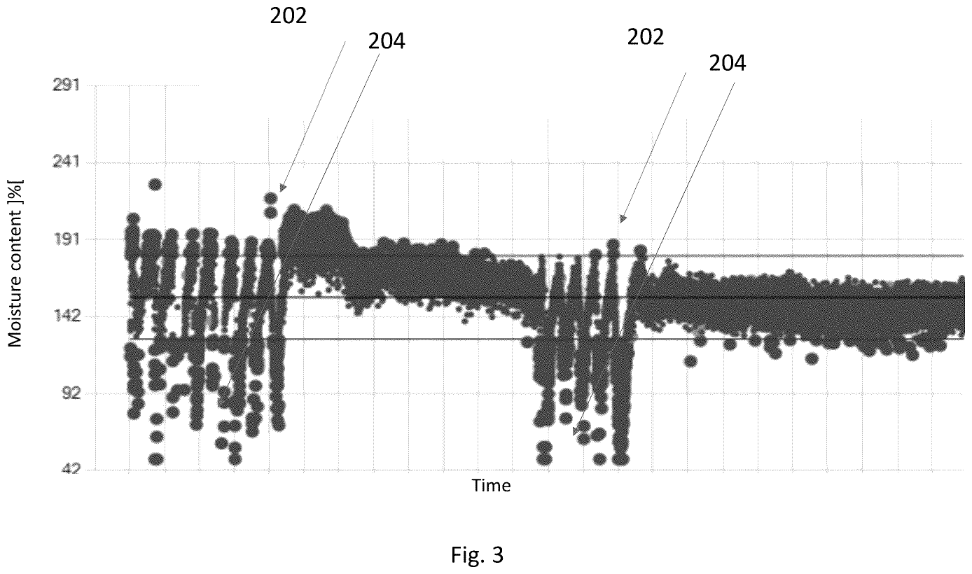

Reference is now made to FIG. 3, which is an exemplary graph showing the moisture content over time as determined using the herein disclosed thermal imaging-based system for evaluating moisture content (here of puffed snacks) exhibiting improper production line functioning. Each dot represents a single snack (or a group of snacks), green dots represent in-range measurements and red dots represent out-of-range measurement. As can be seen in FIG. 3, some of the failure events result in too low moisture content 202 (indication of overbaking/burning of the snack) and others too high moisture content 204. This is indicative of a poorly controlled production process. Advantageously, the system and method enable real-time monitoring of the production line, and real-time/retrospective viewing of the exact time range in which the failure event occurred and its unique pattern, thus easing the determining of the underlying cause of the failure.

As used herein, according to some embodiments, the term “real-time” may relate to a time period of seconds and/or minutes.

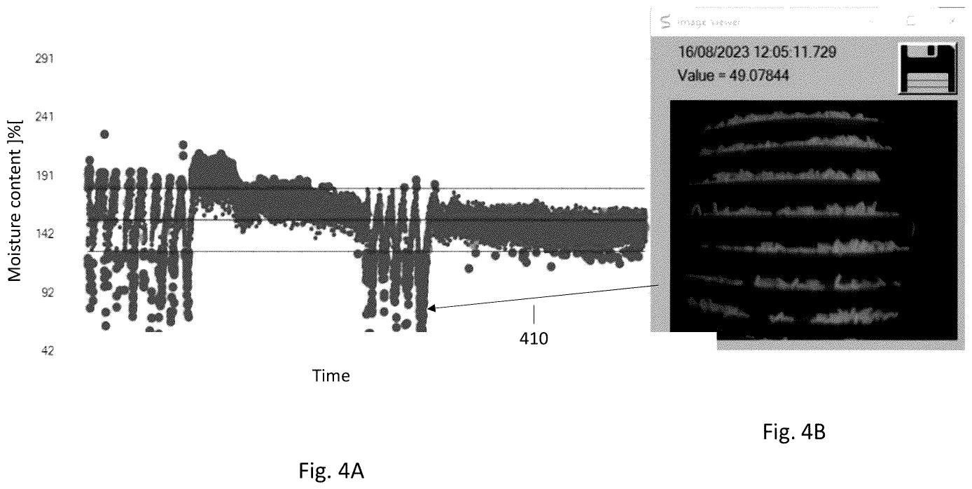

Reference is now made to FIG. 4A and FIG. 4B, which show an exemplary graph and an associated greyscale thermal image, respectively, of a food product conveyed on a conveyer belt after having passed through an improperly working product preparation station (here a heating station). The thermal image (FIG. 4B) represents a specific time point shown in the graph of FIG. 4A (illustrated by an arrow 410), out of numerous such images are obtained over time. In this case, the heating of the product is insufficient, the moisture content is thus high resulting in low grey scale levels Of note, and as clearly seen, the lower the grey scale level, the higher the moisture content percentage in the product.

According to some embodiments, a single image may be used to identify a moisture content percentage at a certain time point. According to some embodiments, a few images (e.g. 2, 3 or 4 images may be used to identify a moisture content percentage for a same time point (e.g. a few seconds apart). According to some embodiments, a plurality of images (e.g., at least 5, at least 10, at least 50, or at least 100) may be used to identify a moisture content percentage and/or a trend in moisture content.

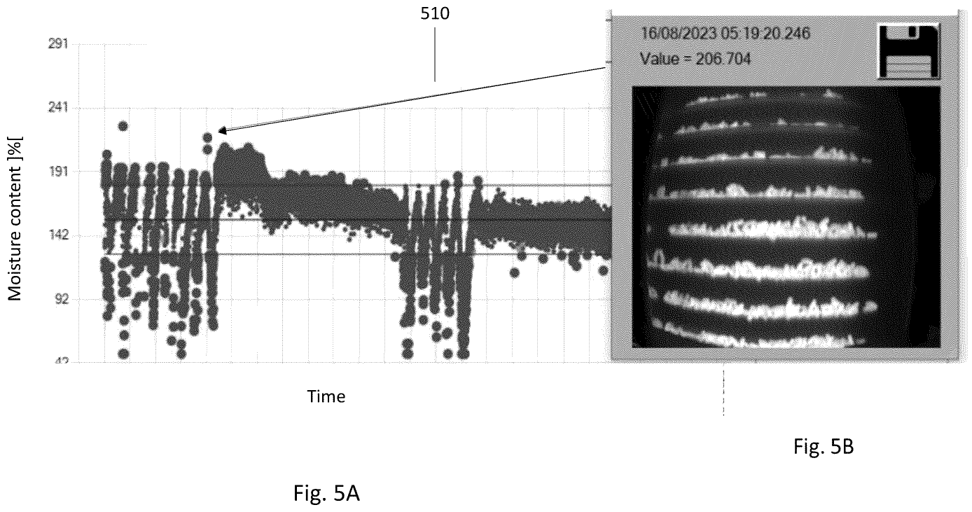

Reference is now made to FIG. 5A and FIG. 5B, which show an exemplary graph and an associated greyscale thermal image, respectively, of a food product conveyed on a conveyer belt after having passed through an improperly working product preparation station (here a heating station) The thermal image (FIG. 5B) represents a specific time point shown in the graph of FIG. 5A (illustrated by an arrow 510), out of numerous such images are obtained over time. In this case, the heating of the product is too extensive, resulting in a below the desired moisture content of the food product.

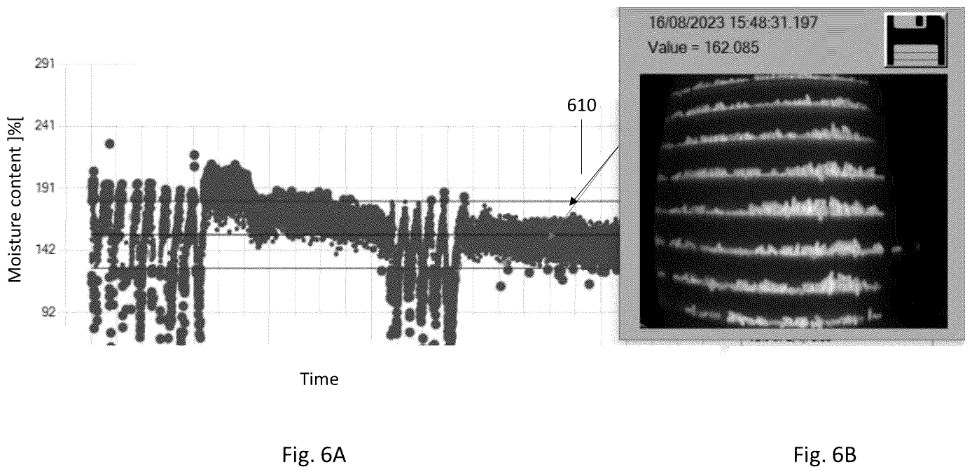

Reference is now made to FIG. 6A and FIG. 6B, which show an exemplary graph and an associated greyscale thermal image, respectively, of a food product conveyed on a conveyer belt after having passed through a recalibrated product preparation station (here a heating station). The thermal image (FIG. 6B) represents a specific time point shown in the graph of FIG. 6A (illustrated by an arrow 610), out of numerous such images are obtained over time. In this case, the heating of the product is within the desired range, as a result of adjustment/calibration in the operation of the product preparation station. It is thus understood that if one or more failure events are detected in the operation of the product preparation station or if a trend indicative of a poorly controlled production process is observed, then the production line may be adjusted until the moisture content percentage falls within the required predetermined range, e.g., as seen in FIG. 6A.

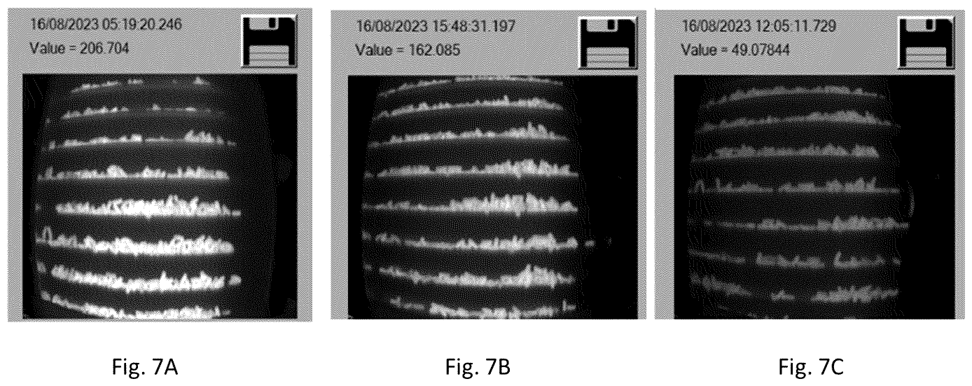

Reference is now made to FIGS. 7A-FIG. 7C, which are exemplary greyscale thermal images of a food product (here a puffed snack) with high moisture content, required moisture content and low moisture content, respectively, in accordance with some embodiments. As seen, the light intensity in the images may be measured from the grey level in the images, for example, in FIG. 7A the grey level is higher than in FIG. 7B, and much higher than in FIG. 7C. The grey level is then translated into moisture content percentage and provided as the x-axis of the graphs of FIG. 4A, FIG. 5A and FIG. 6A.

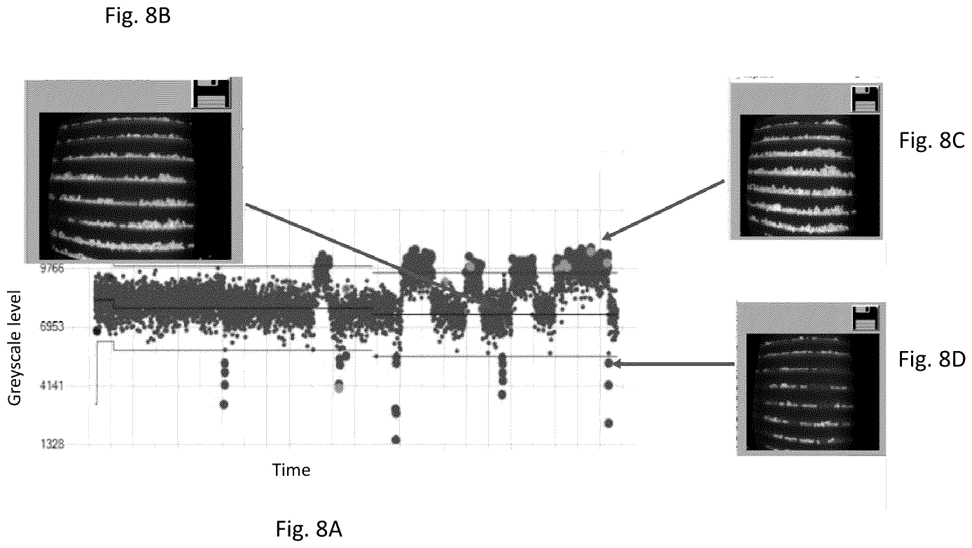

Reference is now made to FIG. 8A-FIG. 8D, which show an exemplary graph and corresponding greyscale thermal images of a production line with a sufficient amount of product (e.g., FIG. 8B), too much product (e.g., FIG. 8C), and an insufficient amount of product (e.g., FIG. 8D), respectively, in accordance with some embodiments. As seen from the images, the amount of food product conveyed is directly correlated with the greyscale intensity, in that low amounts result in low gray scale levels and high levels result in high gray scale intensity. It is thus understood that in addition to evaluation of the moisture content in the food product, the herein disclosed system is likewise capable of the detecting the amount of food product being conveyed over time, and if irregularities are found trigger an adjustment of the production line. According to some embodiments, both grey scale and morphology (structure of the image and intensity/grey scale) is evaluated. According to some embodiments, by combining grey scale and morphology it can be determined whether a defect is a result of a moisture issue (e.g. problem with the product preparation station) or a problem of the size/amount/spread of the products. According to some embodiments, when there is a defect trend, a signal is sent with alerts and an analytical tool (e.g. machine learning algorithm) is applied to enable root cause analysis. In addition, the AI enables providing preventive and predictive alerts based on the big data and the time stamps.

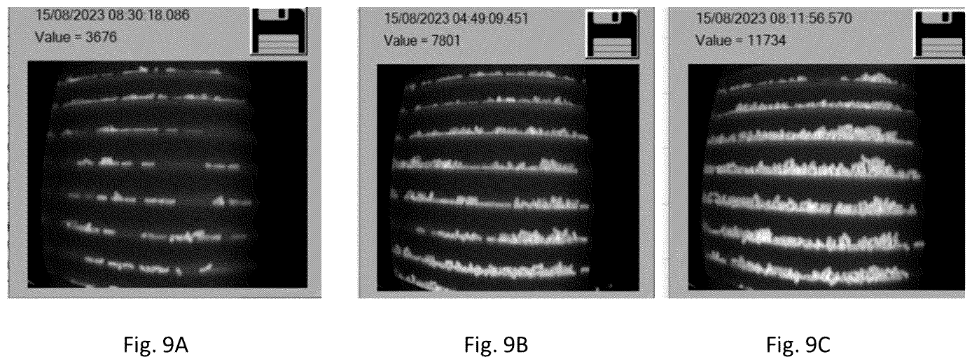

Reference is now made to FIG. 9A-FIG. 9C, which are exemplary greyscale thermal images of a production line with a sufficient amount of product (e.g., FIG. 9B), too much product (e.g., FIG. 9C), and an insufficient amount of product (e.g., FIG. 9A), in accordance with some embodiments.

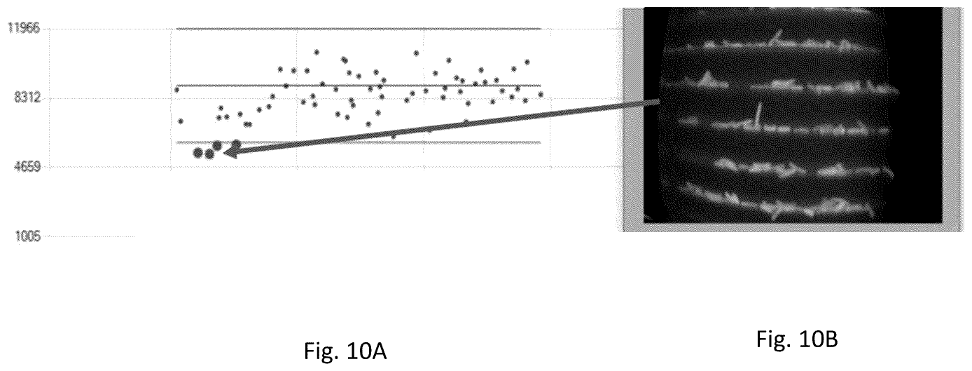

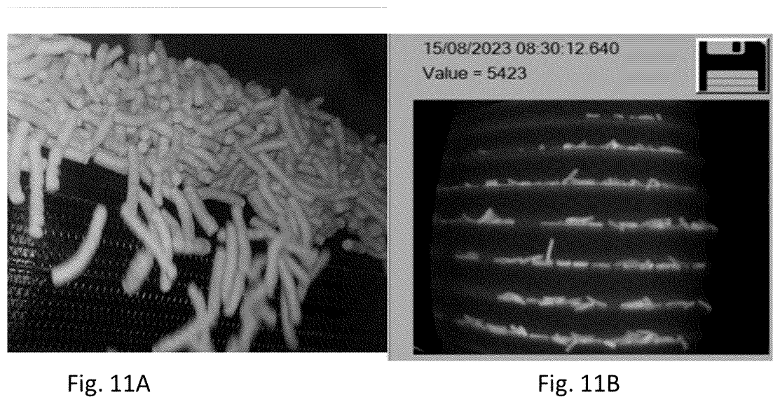

Reference is now made to FIG. 10A and FIG. 10B, which are an exemplary graph and greyscale thermal image of a production line, respectively, showing a failure in an extrusion and/or cutting station of the production line, resulting in size irregularities in the food product, in accordance with some embodiments. It is thus understood that in addition to evaluation of the moisture content in the food product, the herein disclosed system is likewise capable of the detecting the size of a food product being conveyed over time, and if irregularities are found trigger an adjustment of the production line.

Reference is now made to FIG. 11A and FIG. 11B, which are an exemplary optical image and a greyscale thermal image, respectively, of a production line showing a failure an extrusion and/or cutting station of the production line resulting in excessively elongated shape of the food product, in accordance with some embodiments. According to some embodiments, data from one or more imaging sensors (e.g. thermal and visual spectrum images) may be combined to provide a more accurate picture of a production line failure, and/or identification of a trend therein.

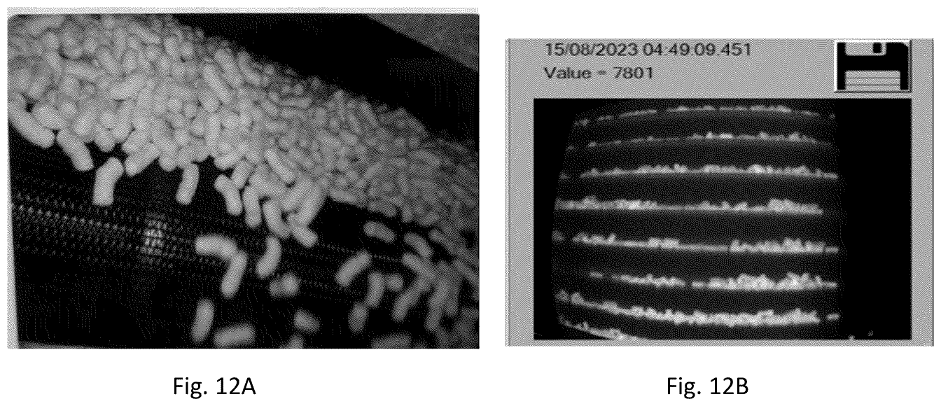

Reference is now made to FIG. 12A and FIG. 12B, which are an exemplary optical image and a greyscale thermal image, respectively, of an extrusion and/or cutting station of a production line functioning within predefined parameters, in accordance with some embodiments.

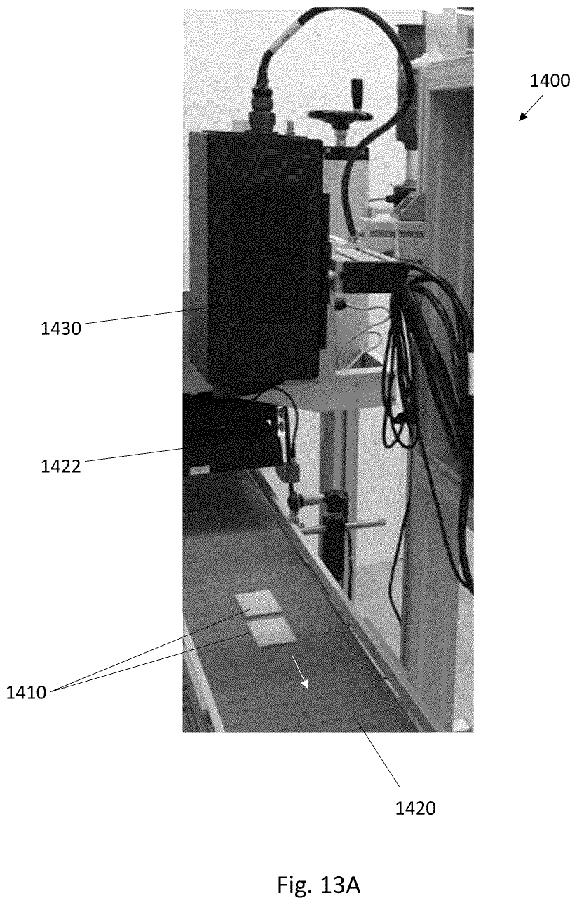

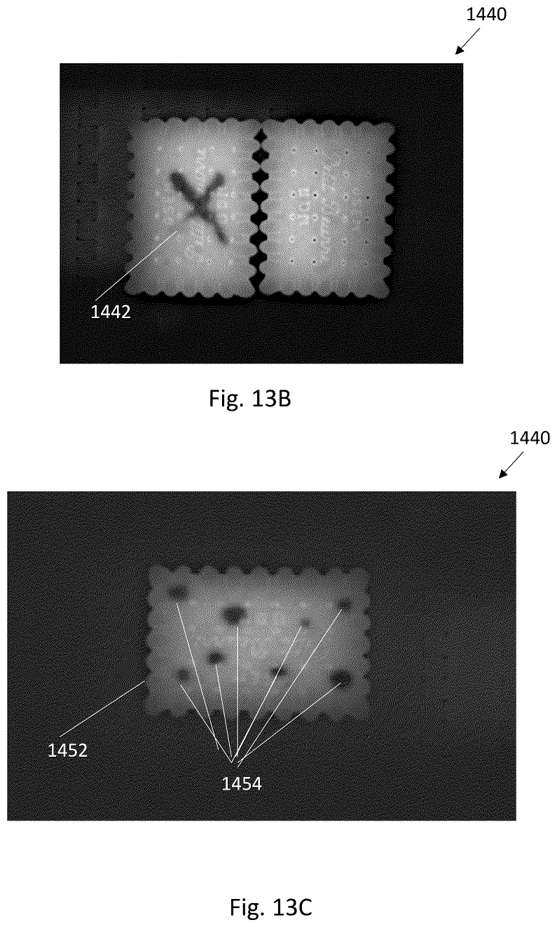

Reference is now made to FIG. 13A-FIG. 13C. FIG. 13A shows a petit bear cookie production line 1400 with two petit bear cookies 1410 on a conveyer belt 1420 being imaged by a thermal imaging camera 1430 after having passed heater 1422. One of petit bear cookies 1410 has been wetted with an x-shape. FIG. 13B shows a greyscale thermal image 1440 obtained from thermal imaging camera 1430 of petit bear cookies 1410. As seen from thermal image 1440, the wet x 1442 on one of petit bear cookies 1410 is readily identified due to its lower grey-scale level (here a grey level of ˜60 digital level units out of 255 digital grey scale units as compared to ˜for the remainder of bear cookies 1410. FIG. 13C shows another greyscale thermal image 1450 obtained from a petit bear cookie 1452, wetted in a spotted manner. As seen from greyscale thermal image 1450, wet spots 1454 are readily observable from thermal image 1450 due to their lower grey-scale level

### EXAMPLES

### Example 1—Conversion of Thermal Signals (DL) to Moisture Content (%)

The herein disclosed thermal-imaging based production line evaluation system was used to image puffed snacks with different moisture content ranging from about 0.88% to 1.49% as measured in lab.

The production line was imaged by several imaging sensors (right side—Table 1, middle—Table 2, left side—Table 3) and the average grey level was calculated from 5 or 10 images taken one after the other with an interval of 5 seconds between subsequent images.

The grey levels were then converted into moisture content using linear regression.

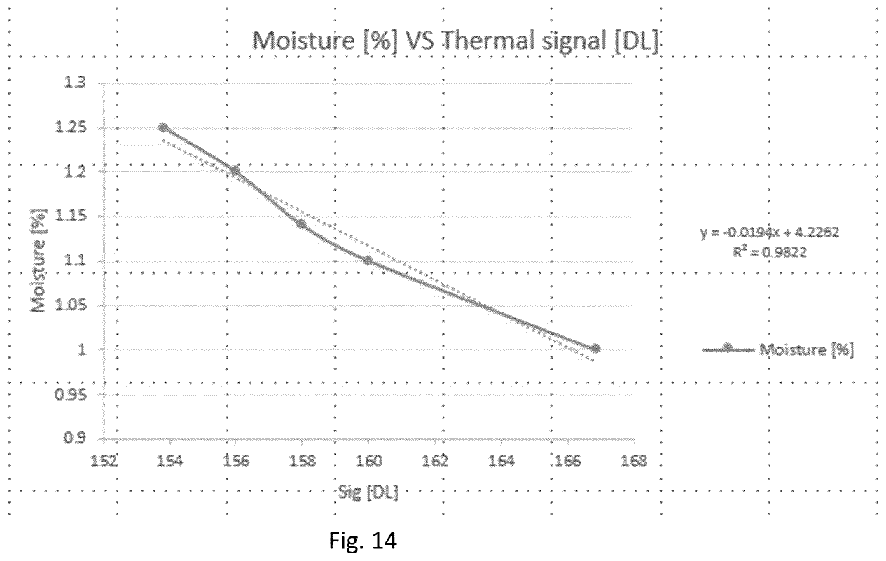

As seen from FIG. 14, an excellent correlation to the measured moisture content was observed, thus demonstrating the ability of the herein disclosed system to accurately assess moisture content in real time and without requiring time-consuming lab analyses.

As seen, the higher the grey level, the lower the moisture content.

TABLE 1
Data from a right side imaging sensor

| | | % Moisture | Grey Level | Grey Level |
|---|---|---|---|---|
| Date | Time | content | Average 10 | Average 5 |
| 14 Aug. 2023 | 14:41:10 | 1.14 | 156.00 | 158.00 |
| 14 Aug. 2023 | 16:01:00 | 1.10 | 159.00 | 160.00 |
| 14 Aug. 2023 | 16:13:00 | 1.20 | 156.00 | 156.00 |
| 14 Aug. 2023 | 16:21:00 | 1.25 | 153.90 | 153.80 |
| 16 Aug. 2023 | 15:45:00 | 1.43 | 149.93 | 149.75 |
| 16 Aug. 2023 | 15:49:30 | 1.39 | 149.80 | 149.00 |
| 16 Aug. 2023 | 20:09:50 | 1.24 | 151.71 | 152.36 |
| 17 Aug. 2023 | 10:59:30 | 1.08 | 161.97 | 161.90 |
| 17 Aug. 2023 | 11:12:35 | 1.00 | 164.63 | 166.85 |
| 17 Aug. 2023 | 11:36:00 | 0.98 | 164.00 | 166.70 |

TABLE 2
Data from a middle imaging sensor

| | | % Moisture | Grey Level | Grey Level |
|---|---|---|---|---|
| Date | Time | content | Average 10 | Average 5 |
| 14 Aug. 2023 | 15:44:00 | 1.08 | 161.68 | 164.40 |
| 14 Aug. 2023 | 15:53:20 | 0.99 | 167.00 | 167.00 |
| 14 Aug. 2023 | 16:04:00 | 0.97 | 167.50 | 167.52 |
| 16 Aug. 2023 | 14:26:00 | 1.36 | 158.05 | 157.04 |
| 16 Aug. 2023 | 14:36:00 | 1.68 | 156.30 | 153.15 |
| 16 Aug. 2023 | 14:48:00 | 1.19 | 164.63 | 162.73 |
| 16 Aug. 2023 | 15:09:30 | 1.39 | 156.33 | 157.00 |
| 16 Aug. 2023 | 15:15:30 | 1.20 | 158.42 | 162.50 |
| 16 Aug. 2023 | 20:19:00 | 1.28 | 157.00 | 162.10 |
| 17 Aug. 2023 | 10:54:05 | 1.39 | 156.50 | 156.85 |

TABLE 3
Data from a left side imaging sensor

| | | % Moisture | Grey Level | Grey Level |
|---|---|---|---|---|
| Date | Time | content | Average 10 | Average 5 |
| 14 Aug. 2023 | 15:22:10 | 1.38 | 140.50 | 139.60 |
| 14 Aug. 2023 | 15:32:00 | 1.31 | 141.50 | 140.85 |
| 16 Aug. 2023 | 14:23:00 | 1.36 | 140.34 | 140.10 |
| 16 Aug. 2023 | 14:33:00 | 1.36 | 140.00 | 140.13 |
| 16 Aug. 2023 | 14:44:00 | 1.49 | 138.93 | 138.60 |
| 16 Aug. 2023 | 15:01:30 | 1.05 | 141.51 | 144.00 |
| 16 Aug. 2023 | 15:54:00 | 1.10 | 142.13 | 142.53 |
| 16 Aug. 2023 | 20:14:30 | 1.28 | 139.08 | 140.50 |
| 17 Aug. 2023 | 10:49:30 | 1.14 | 140.13 | 141.68 |
| 17 Aug. 2023 | 11:04:10 | 1.06 | 141.50 | 142.72 |
| 17 Aug. 2023 | 11:25:30 | 0.88 | 144.89 | 146.90 |

The terminology used herein is for the purpose of describing particular embodiments only and is not intended to be limiting. As used herein, the singular forms “a”, “an” and “the” are intended to include the plural forms as well, unless the context clearly indicates otherwise.

As used herein, according to some embodiments, the term “plurality” may relate to two or more, e.g., 2, 3, 4, 5, 10, 100, 1,000, 10,000, etc.

It will be further understood that the terms “comprises” or “comprising”, when used in this specification, specify the presence of stated features, integers, steps, operations, elements, or components, but do not preclude or rule out the presence or addition of one or more other features, integers, steps, operations, elements, components, or groups thereof.

Unless specifically stated otherwise, as apparent from the following discussions, it is appreciated that throughout the specification discussions utilizing terms such as “processing”, “computing”, “calculating”, “determining”, “estimating”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not Inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

While a number of exemplary aspects and embodiments have been discussed above, those of skill in the art will recognize certain modifications, additions and sub-combinations thereof. It is therefore intended that the following appended claims and claims hereafter introduced be interpreted to include all such modifications, additions, and sub-combinations as are within their true spirit and scope.

1.-40. (canceled)

41. A method for inspecting an operational quality of a production line, the method comprising:
imaging a product on a production line conveyor belt using at least one imaging sensor, wherein the at least one imaging sensor is positioned at or following a product preparation station, to enable imaging of the product after said comestible products exits the product preparation station, and wherein the imaging sensor is operative at a wavelength in the range between about 8 μm-about 14 μm;
measuring a thermal radiation, in at least one image obtained from the imaging;
computing the moisture content of the product based on the measured thermal radiation; and
determining, based on the computed moisture content an operational property of the production line.

42. The method of claim 41, wherein the product preparation station comprises a drying station, a coating station, a baking station, a heating station, a roasting station, or a frying station.

43. The method of claim 41, wherein the imaging comprising obtaining a time stamp for each image captured.

44. The method of claim 41, further comprising detecting an amount and/or spread of the product, based on the at least one image and wherein determining the operational property of the production line is further based on the determined amount and/or spread of the product and determining an operational property of the conveyor of the production line based thereon.

45. The method of claim 41, further comprising detecting a size and/or shape of the produce, based on at least one image and wherein determining the operational property of the production line is further based on the determined size and/or shape of the product and determining an operational property of an extruder of the production line based on the detected size and/or shape.

46. The method of claim 41, wherein computing the moisture content of the product comprises applying an artificial intelligence (AI) algorithm and/or big data analytics on at least one image and wherein determining the operational property of the production line comprises applying an AI algorithm and/or big data analytics on a plurality of images.

47. The method according to claim 41, further comprising computing a trend in a detected and/or predicted moisture content of the product based on the AI algorithm and/or big data analysis, wherein the AI algorithm is configured to conduct a root cause analysis a production line fault based on the trend and wherein the trend is indicative of performance of the production line, a contamination, a deformation, incorrect texture, issue with an ingredient, uneven heating, fluctuation in heating, a decrease or increase in heating station temperature, increased or decreased moisture content of a heating station, humidity along the production line, or any combination thereof.

48. The method according to claim 47, further comprising recommending one or more steps to be taken to correct the fault, based on the root cause analysis.

49. The method according to claim 41, wherein the method further comprises a second imaging by a second imaging sensor configured to image the comestible product at another station of the production line and/or at a different wavelength, wherein the other station is an extrusion station and wherein the different wavelength is in the visible spectrum or UV spectrum.

50. The method according to claim 41, wherein the product is selected from the group consisting of: a coating, a snack, a baked product, a glazed product, a salted food product, a dried food product, pharmaceutical product, cosmetic product, tobacco product, a powder, or any combination thereof.

51. The method according to claim 41, wherein computing the moisture content comprises identifying changes in the moisture percentage level of about 1% or less.

52. A moisture content inspecting system comprising:
a production line comprising a product preparation station;
a first imaging sensor operative at a wavelength in the range between about 8 μm-about 14 μm, wherein the first imaging sensor is positioned at or following the product preparation station, wherein the first imaging sensor is configured image a product conveyed on a conveyor belt of the production line after exiting the product preparation station; and
a processor configured to:
measure a thermal radiation in at least one image obtained from the imaging,
compute the moisture content of the product based on the measured thermal radiation, and
determine based on the computed moisture content, an operational property of the production line.

53. The system of claim 52, wherein the product preparation station comprises a drying station, a coating station, a baking station, a heating station, a roasting station, or a frying station.

54. The system of claim 52, wherein the imaging comprising obtaining a time stamp for each image captured.

55. The system of claim 52, wherein the processor is further configured to detect amount and/or spread of the product and wherein determining the operational property of the production line is further based on the determined amount and/or spread of the product.

56. The system of claim 52, wherein the operational property is a property of the conveyor belt of the production line based thereon.

57. The system of claim 52, wherein the processor is further configured to measure a size and/or shape of the produce, based on at least one image, and wherein determining the operational property of the production line is further based on the determined size and/or shape of the product and wherein the production line further comprises an extruder and wherein the processor is further configured to determine an operational property of the extruder based on the detected size and/or shape.

58. The system of claim 52, wherein computing the moisture content of the product comprises applying an artificial intelligence (AI) algorithm and/or big data analytics on a plurality of images and/or wherein determining the operational property of the production line comprises applying an AI algorithm and/or big data analytics on a plurality of images.

59. The system according to claim 52, wherein the processor is configured to identify a trend in the at moisture content over time, wherein the trend in the moisture content is identified by the applying of the AI algorithm and/or the big data analysis.

60. The system according to claim 52, wherein the system has a sensitivity to a change in the moisture percentage level of about 1% or less.
